(19) United States
(12) Patent Application Publication
(10) Pub. No.: US 2010/0073782 A1
(43) Pub. Date: Mar. 25, 2010

(54) OPTICAL LENS

(75) Inventors: Ju Ho Kim, Gyeonggi-do (KR); Dong Jin Kim, Gyeonggi-do (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/274,637

(22) Filed: Nov. 20, 2008

(30) Foreign Application Priority Data
Sep. 22, 2008 (KR) 10-2008-0092724

(51) Int. Cl. G02B 7/02

(52) U.S. Cl. 359/819

(57) ABSTRACT

Provided is an optical lens including an effective surface on which light is incident; and a rib that extends outward from the effective surface and has barrel contact surfaces on which external forces applied to the outer circumferential surface of the rib act symmetrically with respect to an optical axis of the effective surface.

### CROSS-REFERENCE TO RELATED APPLICATIONS

This application claims the benefit of Korean Patent Application No. 10-2008-0092724 filed with the Korean Intellectual Property Office on Sep. 22, 2008, the disclosure of which is incorporated herein by reference.

### BACKGROUND OF THE INVENTION

1. Field of the Invention

The present invention relates to an optical lens, and more specifically, to an optical lens in which compressive forces are applied symmetrically with respect to an optical axis when the optical lens is coupled to a lens barrel, thereby preventing the optical axis from being distorted.

2. Description of the Related Art

Recently, various types of optical lenses have been developed to achieve a size reduction in optical instruments and to implement multi-functions of the optical instruments. Further, there is demand for developing high-resolution lenses which can cope with the technical development of the optical instruments.

An injection molding method is generally used as a method for molding an optical lens. In the injection molding method, transparent resin such as polyimide is injected into a lens mold, and the lens mold is heated to melt the transparent resin. In this state, the lens mold is pressurized to mold a lens.

The optical lens manufactured by the injection molding method can be precisely molded in a desired shape without a separate finishing process such as a grinding process. Therefore, it is possible to mold an optical lens having an aspheric surface or minute pattern with high precision.

FIG. 1 is a plan view of a conventional optical lens when the conventional optical lens is injection-molded. FIG. 2 is a plan view of the conventional optical lens in a state where the conventional optical lens is coupled to a lens barrel.

Since the conventional optical lens shown in FIG. 1 is manufactured by an injection molding method using a mold, a disk-shaped lens is integrally formed at an end of a runner 20.

The conventional optical lens 10 includes an effective surface 11 on which light is incident and a rib 12 surrounding the outer circumferential surface of the effective surface 11. The end of the runner 20 is coupled to a predetermined position of the outer circumferential surface of the rib 12.

The coupling portion between the lens 10 and the runner 20 is cut by a nipper or cutter 30. The rib 12 formed on the lens 10 has a D-cut portion 13 such that the cutting can be easily performed. As the end of the runner 20 attached to the D-cut portion 13 is cut, the lens 10 can be used as an individual optical lens.

As such, the lens 10 separated from the runner 20 is inserted into a cylindrical lens barrel 40 such that the outer circumferential surface of the rib 11 is closely attached to the inner circumferential surface of the lens barrel 40, as shown in FIG. 2. In this case, a plurality of lenses 10 may be inserted and stacked in the lens barrel 40.

Preferably, the lens 10 is formed in a perfect circle such that the outer circumferential surface of the lens 10 is closely attached to the inner circumferential surface of the lens barrel 40. However, it is difficult to cut the end of the runner 20 such that the rib 12 formed on the outer circumferential surface of the effective surface 11 is formed in a perfect circle. Therefore, the D-cut portion 13 is provided on the rib 12 of the lens 10.

Among optical lenses manufactured in such a manner, optical lenses mounted on mobile devices are injection-molded of a plastic material. Therefore, when the lens assembling is completed by forcing the lens 10 into the lens barrel 40 as shown in FIG. 2, compressive forces are generated from the outer circumferential surface of the rib 12 attached to the inner circumferential surface of the lens barrel 40 toward the inside of the rib 12, and then transmitted through the effective surface 11 of the lens 10.

In this case, however, since the compressive forces are generated through the outer circumferential surface of the lens 10 attached to the lens barrel 40 excluding the D-cut portion 13, the effective surface 11 may be asymmetrically deformed.

Further, optical eccentricity may occur, where the optical axis of the optical lens is distorted by the asymmetrical deformation of the effective surface 11. Then, an image may be asymmetrically formed due to the distortion of the optical axis.

### SUMMARY OF THE INVENTION

An advantage of the present invention is that it provides an optical lens in which compressive forces are applied symmetrically with respect to an optical axis when the optical lens is coupled to a lens barrel, thereby preventing the optical axis from being distorted.

Additional aspect and advantages of the present general inventive concept will be set forth in part in the description which follows and, in part, will be obvious from the description, or may be learned by practice of the general inventive concept.

According to an aspect of the invention, an optical lens comprises an effective surface on which light is incident; and a rib that extends outward from the effective surface and has barrel contact surfaces on which external forces applied to the outer circumferential surface of the rib act symmetrically with respect to an optical axis of the effective surface.

The effective surface may serve as a lens portion which forms a perfect circle and of which one surface or both surfaces is or are convex.

The rib may have cut surfaces formed between the barrel contact surfaces.

The cut surfaces may be set perpendicular to an arbitrary line extending from the optical axis of the effective surface to the outside of the effective surface.

The barrel contact surfaces may be divided to have an equal included angle with respect to the optical axis of the effective surface, and formed in a curved shape having the same curvature as that of the outer circumferential surface of the effective surface.

The barrel contact surfaces and the cut surfaces may be alternately formed along the circumferential surface of the optical lens.

The barrel contact surfaces may be formed at even intervals on the outer circumferential surface of the rib so as to have the same circular-arc length.

The barrel contact surfaces of the rib may be closely attached to the inner circumferential surface of a cylindrical lens barrel.

When the barrel contact surfaces of the rib are closely attached to the inner circumferential surface of the lens barrel, compressive forces may be generated toward the optical axis of the effective surface, and uniformly transmitted to the effective surface with respect to the optical axis such that a resultant force of the compressive forces becomes 0 at the optical axis.

The optical lens may be formed of any one of polyimide resin, acrylic resin, epoxy resin, and polystyrene resin.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a plan view of a conventional optical lens when the conventional optical lens is injection-molded;

FIG. 2 is a plan view of the conventional optical lens in a state where the conventional optical lens is coupled to a lens barrel;

FIG. 3 is a plan view of an optical lens according to an embodiment of the invention;

FIG. 4 is a perspective view of the optical lens of FIG. 3; and

FIG. 5 is a diagram showing a state in which the optical lens of FIG. 3 is mounted in a lens barrel.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures. In the drawings, the thicknesses of layers and regions are exaggerated for clarity.

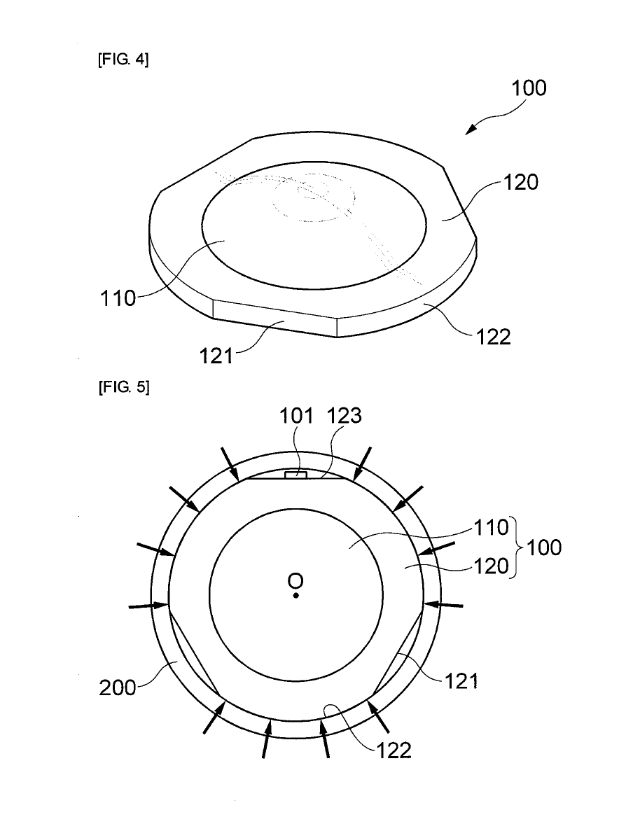

FIG. 3 is a plan view of an optical lens according to an embodiment of the invention. FIG. 4 is a perspective view of the optical lens of FIG. 3. FIG. 5 is a diagram showing a state in which the optical lens of FIG. 3 is mounted in a lens barrel.

As shown in FIG. 3, the optical lens 100 according to the embodiment of the invention includes an effective surface 110 formed in the center thereof, and a rib 120 which extends from the outside of the effective surface 110 and on which compressive forces are applied symmetrically with an optical axis.

The effective surface 110 serves as a lens portion forming a perfect circle with respect to an optical axis O in the central portion thereof. An upper surface or upper and lower surfaces of the effective surface 110 is or are convexly formed in such a manner that external light is normally incident. Further, the light is incident on an image sensor (not shown) through the effective surface 110 while forming a predetermined incident angle.

The rib 120 formed outside the effective surface 110 serves as a fixing element when the optical lens 100 is fixed to a lens barrel 200, and protects the effective surface 100 through which light is incident.

The rib 120 extends from the outer circumferential surface of the effective surface 110 forming a perfect circle, and includes barrel contact surfaces 122 and cut surfaces 121 formed on the outer circumferential surface thereof. The barrel contact surfaces 122 are formed in a curved shape, and the cut surfaces 121 are formed in a straight line shape.

The cut surfaces 121 formed on the rib 120 are set perpendicular to an arbitrary line L extending from the optical axis 0 of the effective surface 110 to the outside of the effective surface 110, and the barrel contact surfaces 122 are provided between the cut surfaces 121.

The barrel contact surfaces 122 are divided so as to have equal included angles θ with respect to the optical axis O of the effective surface 110, and have the same curvature as that of the outer circumferential surface of the effective surface 110.

That is, the barrel contact surfaces 122 formed in a curved shape and the cut surfaces 121 formed in a straight line shape are alternately formed on the circumferential surface of the rib 120 which is the outermost portion forming the optical lens.

In this case, external forces applied from outside are transmitted toward the optical axis O of the effective surface 110 through the barrel contact surface 122 formed in a curved shape. In this case, since the barrel contact surfaces 122 formed at even intervals on the outer circumferential surface of the rib 120 have an equal circular-arc length, the external forces applied to the barrel contact surface 122 are uniformly transmitted to the optical axis O of the effective surface 110.

To construct an optical system, one or more optical lenses 100 according to this embodiment are stacked in a cylindrical lens barrel 200, and sequentially pressed and mounted.

The optical lenses 100 are inserted into the lens barrel 200 such that the barrel contact surfaces 122 of the rib 120 having the same curvature as the effective surface 110 are closely attached to the inner circumferential surface of the lens barrel 200.

That is, the barrel contact surfaces 122 of the rib 120 of the optical lens 100 are closely attached to the inner circumferential surface of the lens barrel 200. At this time, since the optical lens 100 is forced into the lens barrel 200 so as to be mounted and fixed, compressive forces are applied in the direction of the optical axis of the optical lens 100.

The compressive forces formed through the rib 120 extending from the effective surface 110 are transmitted toward to the optical axis 0 of the effective surface 110.

Further, since the barrel contact surfaces 122 of the rib 120 are divided so as to have equal included angles θ with respect to the optical axis O as described above, the compressive forces generated when the barrel contact surfaces 122 come in contact with the inner circumferential surface of the lens barrel 200 are uniformly transmitted toward the optical axis O.

Therefore, a resultant force of the compressive forces of the rib 120 transmitted toward the optical axis O becomes 0 at the optical axis O such that the balance of the compressive forces is achieved. Accordingly, the compressive forces are uniformly transmitted to the effective surface 110 such that the effective surface 110 is prevented from being deformed.

As shown in FIG. 5, a burr 101 is formed on any one of the cut surfaces 121 between the respective barrel contact surfaces 122 formed on the rib 120. The burr 101 is formed by cutting a lens attached to an end of a runner (not shown) after the optical lens 100 is molded.

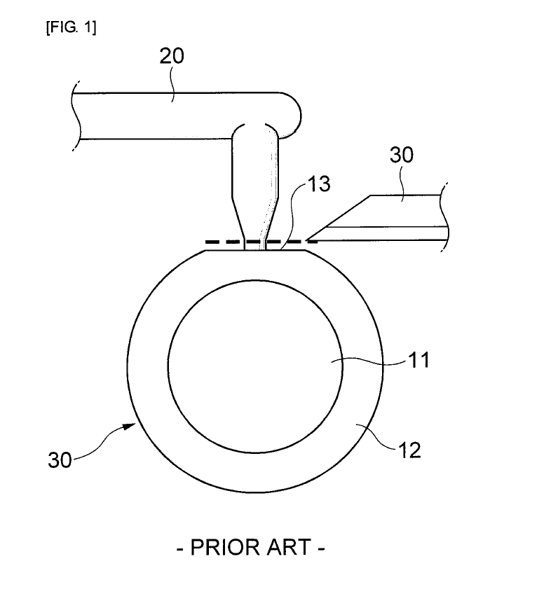

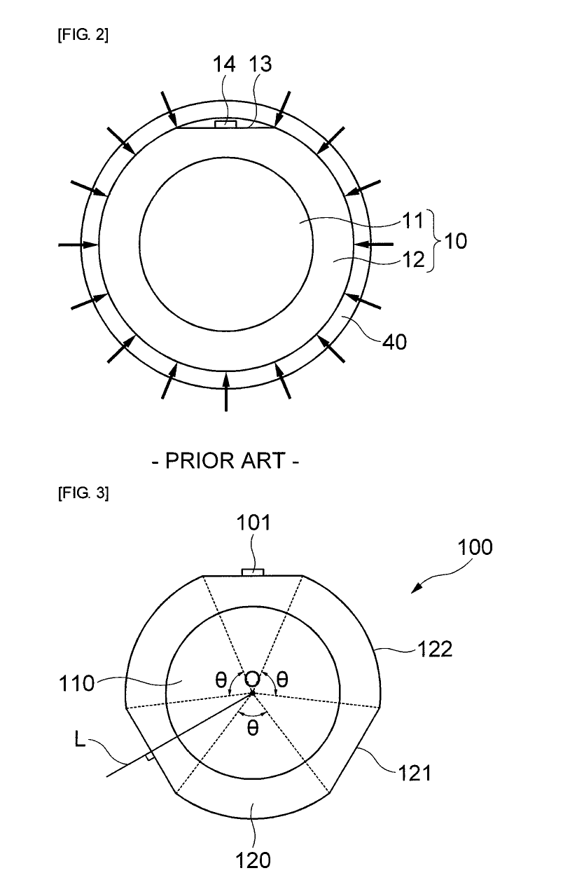

Meanwhile, the optical lens according to this embodiment is manufactured by injection molding. Therefore, after the optical lens is molded in such a manner that a D-cut portion (refer to FIG. 1) is provided on the rib 120 formed outside the effective surface 110, the cut surfaces 121 having a length corresponding to that of the D-cut portion are formed.

At this time, since the cut surfaces 121 are formed at even intervals on the outer circumferential surface of the rib 120 with respect to the optical axis O, the barrel contact surfaces 122 formed between the cut surfaces 121 are formed to have an equal included angle θ.

Further, the optical lens according to this embodiment is manufactured through an injection mold having a cavity through which the barrel contact surfaces 122 and the cut surfaces 121 can be formed on the rib 120 extending from the effective surface 100.

At this time, since the runner supporting the optical lens is attached to any one of the cut surfaces 121, the burr 101 can be formed by cutting the runner.

The optical lens 100 according to this embodiment may be manufactured by another method in addition to the above-described method.

For example, polyimide resin, acrylic resin, epoxy resin, or polystyrene resin may be injected into an injection mold, and then cured to form the optical lens 100 according to this embodiment.

According to the present invention, when the optical lens is mounted in the lens barrel, compressive forces are applied to the rib symmetrically with respect to the optical axis. Therefore, the compressive forces are uniformly transmitted to the effective surface of the lens coupled to the lens barrel, thereby preventing the effective surface from being asymmetrically deformed, which makes it possible to prevent the optical axis from being distorted.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An optical lens comprising:
an effective surface on which light is incident; and
a rib that extends outward from the effective surface and has barrel contact surfaces on which external forces applied to the outer circumferential surface of the rib act symmetrically with respect to an optical axis of the effective surface.

2. The optical lens according to claim 1, wherein the effective surface serves as a lens portion which forms a perfect circle and of which one surface or both surfaces is or are convex.

3. The optical lens according to claim 1, wherein the rib has cut surfaces formed between the barrel contact surfaces.

4. The optical lens according to claim 3, wherein the cut surfaces are set perpendicular to an arbitrary line extending from the optical axis of the effective surface to the outside of the effective surface.

5. The optical lens according to claim 1, wherein the barrel contact surfaces are divided to have an equal included angle with respect to the optical axis of the effective surface, and are formed in a curved shape having the same curvature as that of the outer circumferential surface of the effective surface.

6. The optical lens according to claim 1, wherein the barrel contact surfaces and the cut surfaces are alternately formed along the circumferential surface of the optical lens.

7. The optical lens according to claim 5, wherein the barrel contact surfaces are formed at even intervals on the outer circumferential surface of the rib so as to have the same circular-arc length.

8. The optical lens according to claim 1, wherein the barrel contact surfaces of the rib are closely attached to the inner circumferential surface of a cylindrical lens barrel.

9. The optical lens according to claim 1, wherein when the barrel contact surfaces of the rib are closely attached to the inner circumferential surface of the lens barrel, compressive forces are generated toward the optical axis of the effective surface, and uniformly transmitted to the effective surface with respect to the optical axis such that a resultant force of the compressive forces becomes 0 at the optical axis.

10. The optical lens according to claim 1, wherein the optical lens is formed of any one of polyimide resin, acrylic resin, epoxy resin, and polystyrene resin.
